(19) United States
(12) Patent Application Publication
(10) Pub. No.: US 2022/0193475 A1
(43) Pub. Date: Jun. 23, 2022

(54) ZERO-VALENT METAL AND BLACK CARBON FRAMEWORK AND METHOD OF USING SAME

(71) Applicant: MuniRem Environmental, LLC, Duluth, GA (US)

(72) Inventors: Valentine Asongu Nzengung, Duluth, GA (US); Spencer Asaah Nzengung, Duluth, GA (US); Kagho Nzengung Asongu, Duluth, GA (US)

(21) Appl. No.: 17/557,920

(22) Filed: Dec. 21, 2021

Related U.S. Application Data
(60) Provisional application No. 63/129,944, filed on Dec. 23, 2020.

(51) Int. Cl. A62D 3/37; C01B 32/05; A62D 3/34

(52) U.S. Cl. CPC A62D 3/37; C01B 32/05; A62D 2101/06; C01P 2004/60; A62D 3/34

(57) ABSTRACT

Disclosed are stable zero-valent metal and oxidized black carbon admixtures and their use, to catalyze rapid reductive degradation reactions in aqueous solutions. The compositions and remediation methods are used in the non-explosive neutralization and decomposition of ammonium nitrate.

### CROSS-REFERENCE TO RELATED APPLICATIONS

This application claims the benefit of and priority to U.S. Application No. 63/129,944, filed on Dec. 23, 2020, which is hereby incorporated herein by reference in its entirety.

### FIELD OF THE INVENTION

This invention is generally in the field of remediating hazardous materials, particularly compositions and methods for the neutralization and/or non-explosive destruction of explosive materials, such as ammonium nitrate, preferably in an aqueous medium.

### BACKGROUND OF THE INVENTION

Explosive materials are prevalent throughout the world. Their use is not limited to military applications, but also extend to mining, construction, and fireworks industries. Explosive materials also find use in cars, where small amounts are incorporated into the airbags for rapid inflation during high impact collisions. Generally, making explosive materials is much easier and economical than to dispose of them. Consequently, there has been an accumulation of explosive materials stemming from extended armed conflicts or even from fireworks that have been confiscated and retained in warehouses.

Traditional methods to dispose of these explosive materials have involved deliberate detonation or burning in open fields. However, these processes often generate hazardous byproducts that pollute the air, soil, and surface as well as underground waterways. Some of these byproducts have been linked to various human illnesses, such as cancer and damage to the central nervous system, i.e., they are carcinogenic and/or neurotoxic. Further, various known remediation methods may be disadvantageous for various reasons including, but not limited to, high capital cost, high amount of labor required, and/or high amount of time required for remediation. Accordingly, the development of new compositions and methods for remediating explosive materials remains an unmet need.

Therefore, it is an object of the invention to provide compositions and methods for the remediation of hazardous materials.

It is another objection of the invention to provide compositions and methods for the non-explosive, decomposition and/neutralization of oxidized inorganic compounds, halogenated organic compounds, and/or oxidized organic compounds.

It is a further objection of the invention to provide compositions and methods for the non-explosive, decomposition and/neutralization of inorganic nitrates, such as ammonium nitrate.

### SUMMARY OF THE INVENTION

Disclosed are compositions and remediation methods for the rapid, non-explosive, decomposition and/neutralization of oxidized inorganic compounds, halogenated organic compounds, and/or oxidized organic compounds in aqueous solutions. The compositions contain a mixture of a zero-valent metal and biochar and/or oxybiochar, preferably oxybiochar. The zero-valent metal makes up between 48.8% wt/wt and 78.8% wt/wt, inclusive of the mixture. The zero-valent metal is aluminum in powder form. The biochar and/or oxybiochar make up between 5% wt/wt and 10% wt/wt, inclusive, of the mixture. Preferably, the composition contains oxybiochar, aluminum as the zero-valent metal, and optionally a metal salt such as sodium hydroxide.

The non-explosive, decomposition and/or neutralization occur in an alkali pH of at least 10 or 12, such as between 12 and 13, inclusive, and can be used to effectively decompose and neutralize ammonium nitrate—a well-known explosive material. In some forms, the reaction begins at a pH above 12 (such as pH 13) and upon termination, the pH of the reaction is about 9.

### BRIEF DESCRIPTION OF THE DRAWINGS

FIG. 1 is a process flow diagram showing a non-limiting example of a method for the non-explosive, decomposition and/or neutralization of ammonium nitrate.

FIG. 2 is a condensed process flow diagram showing a non-limiting example of a method for the non-explosive, decomposition and/or neutralization of ammonium nitrate. “AN” denotes ammonium nitrate.

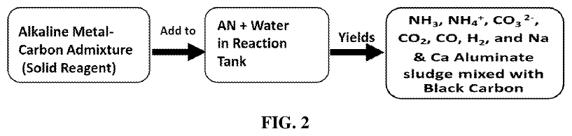

### DETAILED DESCRIPTION OF THE INVENTION

### I. Definitions

“Black carbon” refers to carbonaceous materials obtained from the pyrolysis of biomass or fossil fuel. “Pyrolysis” refers to thermal decomposition of organic matter in the absence or limited supply of oxygen.

“Oxidized black carbon” refers to black carbon that has undergone oxidation. The oxidization of black carbon can be carried out using suitable oxidizing agents, such as alkali or alkali earth metal hydroxides and/or hydrogen peroxides.

The suffix “-based,” as relates to black carbon, oxidized black carbon, and sub-genera or species of these materials, denotes the source of the materials. For example, “plant-based” black carbon refers to black carbon produced from the pyrolysis of plants. “Plants” includes materials from the plant kingdom, such as trees, shrubs, grass, crops, and their components. Similarly, “bamboo-based” black carbon refers to black carbon made from the pyrolysis of bamboo.

“Decomposition” or “destruction” as relates to using a method or composition described herein, refers to the breakdown of a chemical compound in a sample to which the method of composition is being applied. Breakdown of the chemical compound reduces the compound to levels at or below those recommended by the United States Environmental Protection Agency standards (or other local environmental standards), or in some forms to levels below detection limits.

“Mixture” and “admixture” are used interchangeably to refer to a material formed when two or more substances are combined, such that each substance maintains its chemical identity. During the combination, chemical covalent bonds between the substances are neither broken nor formed. Although each substance retains its chemical identity, the combination can display new physical properties, such as boiling point and/or melting point.

“Biochar” refers to a carbon-rich material, produced from pyrolysis of biomass.

“Oxybiochar” refers to oxidized biochar.

“Salt” refers to an ionic compound containing a cation (such as a metal cation) and an anion of a nonmetal or group of nonmetals.

“Zero-valent metal” refers to a metal with an oxidation state of zero.

Use of the term “about” is intended to describe values either above or below the stated value in a range of approx. +/−10%; in other forms, the values may range in value either above or below the stated value in a range of approximately. +/−5%; in other forms, the values may range in value either above or below the stated value in a range of approximately +/−2%; in other forms, the values may range in value either above or below the stated value in a range of approximately. +/−1%. The preceding ranges are intended to be made clear by context, and no further limitation is implied. All methods described herein can be performed in any suitable order unless otherwise indicated herein or otherwise clearly contradicted by context.

### II. Compositions

Described are compositions and remediation methods for the non-explosive, decomposition and/neutralization of oxidized inorganic compounds, halogenated organic compounds, and/or oxidized organic compounds. The compositions and remediation methods provide for the rapid, non-explosive decomposition and/or neutralization of these compounds, preferably in an aqueous environment, such as an aqueous solution. Preferably, the decomposing and/or neutralization of these compounds occurs in the presence of water.

The compositions contain a mixture of (i) a zero-valent metal and (ii) black carbon, oxidized black carbon, or a combination thereof. In preferred embodiments, the mixture contains oxidized black carbon (such as oxybiochar). Preferably, the compositions contain a mixture of (i) a zero-valent metal and (ii) oxidized black carbon.

In some forms, the zero-valent metal is paramagnetic or non-ferromagnetic. In some forms, the zero-valent metal is not iron. In some forms, the zero-valent metal has three valence electrons, is a p-block metal of the periodic table, or a combination thereof. In some forms, the zero-valent metal is a Group 13 metal of a periodic table. In some forms, the zero-valent metal is aluminum. In still other forms, the zero-valent metal is in a powder form.

In some forms, the zero-valent metal makes up between about 48.8% wt/wt and about 78.8% wt/wt, inclusive, 55% wt/wt and 85% wt/wt, inclusive, 55% wt/wt and 80% wt/wt, inclusive, 50% wt/wt and 85% wt/wt, inclusive, or 50% wt/wt and 80% wt/wt, inclusive, of the mixture. In some forms, the zero-valent metal makes up between 48.8% wt/wt and 78.8% wt/wt, inclusive of the mixture.

In some forms, the composition further contains a metal salt. In some forms, the metal salt contains an alkali metal, an alkaline earth metal, or a salt of the zero-valent metal, or a combination thereof. In some forms, the metal salt contains an alkali metal, an alkaline earth metal, or a combination thereof. In some forms, the metal salt contains sodium hydroxide, calcium hydroxide, or a combination thereof. In some forms, the metal salt contains a salt of the zero-valent metal. In some forms, the salt contains a hydroxide, oxide, sulfate, or sulfite. In some forms, the salt is a hydroxide of the metal salt. These salts, such as sulfate and sulfite, can lead to the formation of a double layer of silicates, effective in absorbing anions and cations. Further, these salts can be introduced into the mixture based on the source of the zero-valent metal, such as aluminum materials that have a high level of purity (e.g., 99.9% pure) from aluminum cans, aluminum foil, or aluminum dross from aluminum manufacture. In some forms, the composition contains a mixture of aluminum as the zero-valent metal and optionally sodium hydroxide as the metal salt.

In some forms, the black carbon, oxidized black carbon, or combination thereof, is based on biomass. Preferably, the compositions contain oxidized black carbon. In some forms, the black carbon, oxidized black carbon, or combination thereof, is plant-based. In some forms, the black carbon, oxidized black carbon, or combination thereof, is wood-based, crop-based, or a combination thereof. In some forms, the black carbon, oxidized black carbon, or combination thereof, is bamboo-based, softwood-based, hardwood-based, peanut hull-based, wheat straw-based, rice straw-based, maize straw-based, rice husk-based, coconut shell-based, or a combination thereof. In some forms, the black carbon, oxidized black carbon, or combination thereof is bamboo-based. In some forms, the black carbon contains biochar. In some forms, the oxidized black carbon contains oxybiochar.

In some forms, the black carbon, oxidized black carbon, or combination thereof makes up between 1% wt/wt and 20% wt/wt, inclusive, 1% wt/wt and 15% wt/wt, inclusive, 1% wt/wt and 10% wt/wt, inclusive, 5% wt/wt and 20% wt/wt, inclusive, 5% wt/wt and 15% wt/wt, inclusive, or 5% wt/wt and 10% wt/wt, inclusive, of the mixture. In some forms, the black carbon, oxidized black carbon, or combination thereof makes up between 5% wt/wt and 10% wt/wt, inclusive, of the mixture. In some forms, the black carbon, oxidized black carbon, or combination thereof makes up about 7.3% wt/wt, of the mixture. In some forms, the black carbon, oxidized black carbon, or combination thereof makes up about 5% wt/wt of the mixture.

In some forms, the mixture is in particulate form having particle sizes between 2 mesh and 20 mesh, inclusive, between 2 mesh and 15 mesh, inclusive, or between 2 mesh and 10 mesh, inclusive, as measured using particle size analyzers known to those of skill in the art, which depend on the sizes of the particles being measured.

In some forms, the size of the zero-valent metal in the mixture is between 2 mesh and 20 mesh, inclusive, between 2 mesh and 15 mesh, inclusive, between 2 mesh and 10 mesh, inclusive, or 2 mesh and 5 mesh, inclusive, as measured using particle size analyzers known to those of skill in the art, which depend on the sizes of the particles being measured.

In some forms, the size of the black carbon or oxidized black carbon in the mixture is between 2 mesh and 20 mesh, inclusive, between 2 mesh and 15 mesh, inclusive, between 2 mesh and 10 mesh, inclusive, or 2 mesh and 5 mesh, inclusive, as measured using particle size analyzers known to those of skill in the art, which depend on the sizes of the particles being measured.

In some forms, the size of the biochar or oxybiochar in the mixture is between 2 mesh and 20 mesh, inclusive, between 2 mesh and 15 mesh, inclusive, between 2 mesh and 10 mesh, inclusive, or 2 mesh and 5 mesh, inclusive, as measured using particle size analyzers known to those of skill in the art, which depend on the sizes of the particles being measured.

A mixture can contain particles of black carbon and/or oxidized black carbon adsorbed with particles of a zero-valent metal. A mixture can contain particles of black carbon and/or oxidized black carbon and particles of a zero-valent metal, not adsorbed with each other. A mixture can contain a combination of (i) particles of black carbon and/or oxidized black carbon adsorbed with particles of a zero-valent metal and (ii) particles of black carbon and/or oxidized black carbon and particles of a zero-valent metal not adsorbed with each other.

A mixture can contain particles of biochar and/or oxybiochar adsorbed with particles of a zero-valent metal. A mixture can contain particles of biochar and/or oxybiochar and particles of a zero-valent metal, not adsorbed with each other. A mixture can contain a combination of (i) particles of biochar and/or oxybiochar adsorbed with particles of a zero-valent metal and (ii) particles of biochar and/or oxybiochar and particles of a zero-valent metal not adsorbed with each other.

In some forms, the composition is in solid form, and the mixture contains aluminum as the zero-valent metal, oxybiochar as the oxidized black carbon, and optionally sodium hydroxide as the metal salt.

### III. Methods of Making and Reagents Therefor

The black carbon described herein, can be obtained via pyrolysis of biomass or fossil fuel. Preferably, the black carbon is obtained from pyrolysis of biomass. Temperatures at which the pyrolysis is carried out can be temperatures between 300° C. and 1000° C., inclusive, such as temperatures between 500° C. and 1000° C., inclusive, 600° C. and 1000° C., inclusive, 450° C. and 700° C., inclusive, 350° C. and 450° C., inclusive, or 300° C. and 450° C., inclusive. Suitable periods for pyrolysis can be between 1 hour and 16 hours, such as 1 hour, 2 hours, 3 hours, 4 hours, 5 hours, 8 hours, 10 hours, 15 hours, or 16 hours. For example, wood biochar can be produced by subjecting wood to pyrolysis a temperature between 500° C. and 1,000° C., inclusive, or 500° C. and 1,000° C., inclusive, for a maximum of 4 hours. Other biochars such as peanut hull and non-woody biomass can be produced by subjecting peanut hall and non-woody biomass, respectively, to a pyrolysis temperature between 300° C. and 450° C., inclusive, or 350° C. and 450° C., inclusive, for 1 hour. Other types of biochars, such as bamboo-based biochar, softwood-based biochar, and/or hardwood-based biochar can be obtained from commercial sources.

The oxidized black carbon can be obtained by oxidation of black carbon using suitable oxidizing reagents that include, but are not limited to, alkali or alkali earth metal hydroxides and/or hydrogen peroxides.

The zero-valent metal can be obtained from discarded materials containing metals in their elemental state, i.e., at an oxidation state of zero. The materials can be physically processed into a form that is suitable for converting into a form suitable for mixing with the black carbon or oxidized black carbon. Suitable forms for mixing include, but are not limited to, powders, spheres, fibers, strands, rings, etc., preferably powders.

In some forms, the zero-valent metal can be formed from reduction of salts of the metals prior to combining with the black carbon or oxidized black carbon. In some forms, the zero-valent metal can be formed in situ in the presence of the biomass, through reductive calcination of the biomass at a temperature less than 1000° C., such as between 300° C. and 1000° C., inclusive.

Preferably, the produced black carbon and/or oxidized black carbon is mixed with zero-valent metal to form the zero-valent metal and black carbon or oxidized black carbon admixtures.

As described above, the mixture can be in particulate form. Particles of the zero-valent metal can be obtained from commercial sources at a desired size. Alternatively, raw metallic materials of the zero-valent metal, such as cans, foils, pipes, etc. can be cut to suitable sizes and processed in a ball mill to generate particles. Processing in the ball mill can occur in the presence or absence of black carbon (such as biochar) and/or oxidized black carbon (such as oxybiochar). If needed, the commercially obtained particles, ball mill-processed particles, black carbon (such as biochar), oxidized black carbon (such as oxybiochar), or a combination thereof, can be sieved to obtain the particle sizes described herein.

### IV. Methods of Using

The disclosed compositions and remediation methods can be used for the non-explosive, decomposition and/neutralization of oxidized inorganic compounds, halogenated organic compounds, and/or oxidized organic compounds. Preferably, decomposing the oxidized inorganic compounds, halogenated organic compounds, and/or oxidized organic compounds occurs in an aqueous environment, such as an aqueous solution. In some forms, decomposing the oxidized inorganic compounds, halogenated organic compounds, and/or oxidized organic compounds occurs in alkaline pH. In some forms, the alkaline pH is at least 12. NaOH and/or Ca(OH)₂ can be used to obtain a pH of at least 12 when stimulating or initiating the reaction. However, in some forms, steel slag and/or oxidized black carbon (such as oxybiochar) reduces the need for higher concentrations of NaOH and Ca(OH)₂, such that the pH is >10. Therefore, in some forms, the alkaline pH is at least 10. In some forms of the method, the decomposition reaction is initially conducted by adding an alkaline earth metal salt (such as Ca(OH)₂) to the composition and allowing the reaction to proceed for a suitable time. Suitable times can be from about 1 min to about 1 hour, about 1 min to about 2 hours, or about 1 min to about 3 hours. After this time, an alkali metal salt (such as NaOH) is added to the reaction, and the reaction is allowed to proceed more rapidly to an endpoint.

In some forms, the alkaline pH is between 12 and 13, inclusive.

The oxidized inorganic compounds, halogenated organic compounds, and/or oxidized organic compounds may be present in soil and/or water where, for example, munitions are tested, deployed (e.g., battlefields), stored, and/or disassembled. Such oxidized inorganic compounds, halogenated organic compounds, and/or oxidized organic compounds may also be present in soil and/or water near munitions manufacturing facilities. Further, unexploded ordnance (UXO) devices may contain oxidized inorganic compounds, halogenated organic compounds, and/or oxidized organic compounds (e.g., energetic compounds and/or explosives) and may be located on or in soil (i.e., on or in earth) and/or water (e.g., salt water). Some UXO devices may be underwater unexploded ordnance (UWUXO) devices that contain energetic compounds and/or explosives and may be located in artificial or natural bodies of water (e.g., rivers, lakes, oceans, etc.).

In some forms, the oxidized inorganic compounds include, but are not limited to, inorganic nitrate compounds. The inorganic nitrate compounds may contain metals or non-metals. In some forms, the inorganic nitrate compounds are alkali metal nitrates, i.e., nitrates of Group 1 elements. In some forms, the inorganic nitrate compound is ammonium nitrate.

In some forms, the halogenated organic compounds include, but are not limited to, trichloroethylene, tetrachloroethylene, sulfur mustard (a chemical warfare agent), tetrachlorobenzene, chlorotrinitrobenzene, bis(trichloromethyl)carbonate, fluorotrinitrobenzene, 1,2-Bis(2,2-difluoro-2-nitroacetoxyethane), etc.

In some forms, the oxidized organic compounds include, but are not limited to, organic compounds that include one or more nitro- (—NO₂) groups. In some forms, the oxidized organic compounds may be octahydro-1,3,5,7-tetranitro-1,3,5,7-tetrazocine (HMX), 2,4,6-trinitrotoluene (TNT), 1,3,5-trinitro-1,3,5-triazine (RDX), trinitrobenzenes (TNB), nitrobenzene, nitrocellulose, nitroglycerin, nitromethane, aminodinitrotoluenes (ADNTs), diaminonitrotoluenes (DANTs), 2,4,6-trinitrophenol (TNP), triamino-trinitrobenzene (TATNB), dinitrotoluenes (DNTs), 2,4,6-trinitrophenyl-N-methylnitramine, and combinations thereof. In some forms, oxidized organic compounds include energetic compounds (i.e., propellants, fuels, etc.) and/or explosives. Energetic compounds and/or explosives are compounds that may, under certain conditions, explode upon application of heat and/or shock. For example, an explosive (e.g., TNT) may be characterized by chemical stability, but may be made to undergo rapid chemical change, whereupon it may produce a large quantity of energy.

In more specific forms, the disclosed compositions and remediation methods can be used in (a) non-explosive destruction of bulk ammonium nitrate and its constituents, preferably in aqueous solution; (b) non-thermal disposal of ammonium nitrate explosives and sludge from ammonium nitrate explosives manufacture; (c) remediation of ammonium nitrate spills; (d) reductive dehalogenation of halogenated organic compounds.

The zero-valent metal and black carbon or oxidized black carbon admixture when mixed with aqueous solutions of ammonium nitrate at pH of >12 produces an exothermic and rapid decomposition reaction with the evolution of gases, such as hydrogen, carbon dioxide, and carbon monoxide gases. In some forms, the pH of the reaction remains above 12 at the end of the decomposition reaction. In other forms, the pH of the reaction drops to about 9. The residual solids at the end of the reaction include sodium aluminate, calcium aluminate, aluminum oxide, aluminum hydroxide, and residual unoxidized black carbon. The zero-valent metal and black carbon or oxidized black carbon admixture is effective for neutralization and destruction of ammonium nitrate, preferably non-explosively. In some forms, the reaction is complete in under three hours.

Further, the sodium aluminate (Na₂Al₂O₄) and calcium aluminate generated as sludge from the reaction can be applied in the solidification of concrete (e.g., ecocement made from ground glass and paper waste sludge ash), for the sorption and precipitation of boron, bromide and other metals in coal ash and similar wastes, or a combination thereof. Further, the calcium aluminate and sodium aluminate precipitates can be dissolved using a solution of glycolic acid or urea hydrochloride. Effectively, the compositions and methods described herein, can be used for the recycling of aluminum into other useful products.

In some forms, a reaction of the produced zero-valent metal and black carbon or oxidized black carbon admixtures is achieved under one or more reaction conditions selected from the following:

(1) Particle size of the zero-valent metal and black carbon or oxidized black carbon mixture (2 mesh-10 mesh);

(2) The black carbon is produced from different biomass by pyrolysis at temperature between 450° C. and 700° C., inclusive;

(3) The use of bamboo-based biochar;

(4) The use of oxybiochar, i.e., biochar prepared by oxidizing the biochar with alkali or alkali earth metal hydroxides and/or hydrogen peroxides. Preferably, these are performed using oxybiochar. In some forms, the oxybiochar performed significantly better than the corresponding biochar. The oxybiochar can be bamboo-based, non-bamboo-based, or a combination thereof.

In some forms, the oxybiochar is non-bamboo-based;

(5) The fraction of black carbon in the zero-valent metal and black carbon or oxidized black carbon between 5% wt/wt and 10% wt/wt of the total admixture or mixture; and/or

(6) pH of the aqueous ammonium nitrate solution is adjusted to pH between 12 and 13, inclusive, to stimulate and enhance the reaction.

Exemplary selections of reaction conditions include:

(i) (1), (2), (3), (4), (5), or (6);

(ii) (1) and (2), (1) and (3), (1) and (4), (1) and (5), or (1) and (6);

(iii) (1), (2), and (3); (1), (2), and (4); (1), (2), and (5), or (1), (2), and (6);

(iv) (1), (2), (3), (5), and (6); or (1), (2), (4), (5), and (6); or

(v) (1), (2), (3), (4), (5), and (6).

In some forms, the remediation method is performed in a heat-exchange reactor. Heat exchange reactors typically contain a chamber in which a reaction occurs. The chamber is operably linked to another chamber through which a heat exchange fluid flows and transmits or absorbs heat energy from or to the chamber in which the reaction is occurring. In the case of an exothermic reaction, the heat exchange fluid absorbs heat energy from the chamber. The heat exchange fluid may undergo a partial or full phase change. This phase change can provide additional heat removal from the chamber beyond that provided by convective cooling.

Those of skill in the art would readily understand, given the current reaction conditions, that (i) to (v) are non-limiting selections, and additional reaction conditions can be selected from conditions (1), (2), (3), (4), (5), and (6).

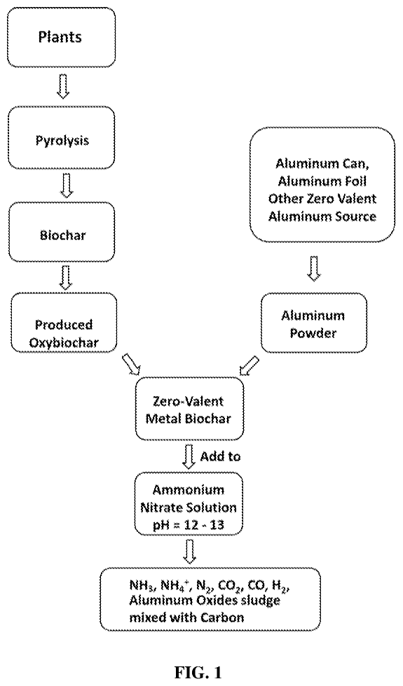

FIG. 1 shows a non-limiting example of one use of the disclosed composition and remediation methods. The biochar is obtained from pyrolysis of plants. Optionally, the biochar can be oxidized using reagents such as with alkali or alkali earth metal hydroxides and/or hydrogen peroxides, to produce oxybiochar. In some preferred forms, the biochar is oxidized to produce oxybiochar, as discussed herein. Aluminum powder is obtained from aluminum can, aluminum foil, aluminum dross, or other zero-valent aluminum source(s), such as commercial sources. The biochar, oxybiochar, or both can then be mixed with the aluminum powder to form the zero-valent metal biochar or oxybiochar. As shown in FIG. 1, the admixed zero-valent metal biochar or oxybiochar is combined with an aqueous ammonium nitrate solution at a pH between 12 and 13, inclusive. As shown in FIG. 1, non-explosive decomposition of ammonium nitrate leads to the formation of ammonia, ammonium ion, carbon dioxide, carbon monoxide, hydrogen, and oxidized aluminum sludge mixed with carbon.

The disclosed compositions and methods can be further understood through the following enumerated paragraphs or embodiments.

1. A composition containing a mixture of:

(i) a zero-valent metal, and

(ii) oxidized black carbon.

2. The composition of paragraph 1, wherein the zero-valent metal is paramagnetic or non-ferromagnetic, preferably wherein the zero-valent metal is not iron.

3. The composition of paragraph 1 or 2, wherein the zero-valent metal has three valence electrons, is a p-block metal of the periodic table, or a combination thereof.

4. The composition of any one of paragraphs 1 to 3, wherein the zero-valent metal is a Group 13 metal of a periodic table.

5. The composition of any one of paragraphs 1 to 4, wherein the zero-valent metal is aluminum.

6. The composition of any one of paragraphs 1 to 5, wherein the zero-valent metal is in a powder form.

7. The composition of any one of paragraphs 1 to 6, wherein the zero-valent metal contains between about 48.8% wt/wt and about 78.8% wt/wt, 55% wt/wt and 85% wt/wt, inclusive, 55% wt/wt and 80% wt/wt, inclusive, 50% wt/wt and 85% wt/wt, inclusive, or 50% wt/wt and 80% wt/wt, inclusive, of the mixture.

8. The composition of any one of paragraphs 1 to 7, wherein the zero-valent metal contains between about 48.8% wt/wt and about 78.8% wt/wt, preferably between 48.8% wt/wt and 78.8% wt/wt, inclusive, of the mixture.

9. The composition of any one of paragraphs 1 to 8, further containing a metal salt.

10. The composition of paragraph 9, wherein the salt contains a hydroxide, oxide, sulfate, sulfite, or a combination thereof.

11. The composition of paragraph 9 or 10, wherein the salt contains a hydroxide.

12. The composition of any one of paragraphs 9 to 11, wherein the metal salt contains an alkali metal, an alkaline earth metal, a salt of the zero-valent metal, or a combination thereof.

13. The composition of any one of paragraphs 9 to 12, wherein the metal salt contains an alkali metal, an alkaline earth metal, or a combination thereof.

14. The composition of any one of paragraphs 9 to 13, wherein the metal salt contains sodium hydroxide, calcium hydroxide, or a combination thereof, preferably, sodium hydroxide.

15. The composition of paragraph 14, wherein the zero-valent metal is aluminum.

16. The composition of any one of paragraphs 9 to 12, wherein the metal salt contains a salt of the zero-valent metal.

17. The composition of any one of paragraphs 1 to 16, wherein the oxidized black carbon is based on biomass.

18. The composition of any one of paragraphs 1 to 17, wherein the oxidized black carbon is plant-based.

19. The composition of any one of paragraphs 1 to 18, wherein the oxidized black carbon is wood-based, crop-based, or a combination thereof.

20. The composition of any one of paragraphs 1 to 19, wherein the oxidized black carbon is bamboo-based, softwood-based, hardwood-based, peanut hull-based, wheat straw-based, rice straw-based, maize straw-based, rice husk-based, coconut shell-based, or a combination thereof.

21. The composition of any one of paragraphs 1 to 20, wherein the oxidized black carbon is bamboo-based.

22. The composition of any one of paragraphs 1 to 21, wherein the oxidized black carbon constitutes between 1% wt/wt and 20% wt/wt, inclusive, 1% wt/wt and 15% wt/wt, inclusive, 1% wt/wt and 10% wt/wt, inclusive, 5% wt/wt and 20% wt/wt, inclusive, 5% wt/wt and 15% wt/wt, inclusive, or 5% wt/wt and 10% wt/wt, inclusive, of the mixture.

23. The composition of any one of paragraphs 1 to 22, wherein the oxidized black carbon constitutes between 5% wt/wt and 10% wt/wt, inclusive, of the mixture.

24. The composition of any one of paragraphs 1 to 23, wherein the oxidized black carbon constitutes about 7.3% wt/wt, of the mixture.

25. The composition of any one of paragraphs 1 to 23, wherein the oxidized black carbon constitutes about 5% wt/wt of the mixture.

26. The composition of any one of paragraphs 1 to 25, wherein the mixture is in particulate form having particles with particle sizes between 2 mesh and 20 mesh, inclusive, between 2 mesh and 15 mesh, inclusive, or between 2 mesh and 10 mesh, inclusive.

27. The composition of paragraph 26, wherein the particles contain:

(i) particles of oxidized black carbon adsorbed with particles of the zero-valent metal,

(ii) particles of oxidized black carbon and particles of the zero-valent metal, not adsorbed with each other, or

(iii) a combination of (i) and (ii).

28. The composition of any one of paragraphs 1 to 27, wherein the oxidized black carbon contains oxybiochar.

29. The composition of any one of paragraphs 1 to 28 in solid form, wherein the mixture contains sodium hydroxide, aluminum, and oxybiochar.

30. A remediation method for decomposing oxidized inorganic compounds, halogenated organic compounds, and/or oxidized organic compounds, the remediation method involving:

contacting the oxidized inorganic compounds, halogenated organic compounds, and/or oxidized organic compounds with the composition of any one of paragraphs 1 to 29.

31. The method of paragraph 30, comprising first adding an alkaline earth metal salt to the composition and allowing a decomposition to proceed.

32. The method of paragraph 31, comprising subsequently adding an alkaline metal salt to the decomposition reaction after about 1 min to about 1 hour, about 1 min to about 2 hours, or about 1 min to about 3 hours.

33. The method of any of paragraphs 30 to 32, wherein decomposing the oxidized inorganic compounds, halogenated organic compounds, and/or oxidized organic compounds occurs in an aqueous environment, such as an aqueous solution.

34. The method of any of paragraphs 30 to 33, wherein decomposing the oxidized inorganic compounds, halogenated organic compounds, and/or oxidized organic compounds occurs in the presence of water.

35. The method of any one of paragraphs 30 to 34, wherein decomposing the oxidized inorganic compounds, halogenated organic compounds, and/or oxidized organic compounds occurs in alkaline pH.

36. The method of paragraph 35, wherein the alkaline pH is at least 10 or at least 12.

37. The method of paragraph 35 or 36, wherein the alkaline pH is between 12 and 13, inclusive.

38. The remediation method of any one of paragraphs 30 to 37 for decomposing the oxidized inorganic compounds, the remediation method involving contacting the oxidized inorganic compounds with the composition of any one of paragraphs 1 to 29.

39. The remediation method of any one of paragraphs 30 to 38, wherein the oxidized inorganic compounds contain inorganic nitrate compounds.

40. The remediation method of paragraph 39, wherein the inorganic nitrate compounds contain ammonium nitrate, alkali metal nitrates, or a combination thereof.

41 The remediation method of paragraph 39 or 40, wherein the inorganic nitrate compounds contain ammonium nitrate.

42. The remediation method of any one of paragraphs 30 to 37 for decomposing the halogenated organic compounds, the remediation method involving contacting the halogenated organic compounds with the composition of any one of paragraphs 1 to 29.

43. The remediation method of any one of paragraphs 30 to 37, or 42, wherein the halogenated organic compounds contain trichloroethylene, tetrachloroethylene, sulfur mustard (a chemical warfare agent), tetrachlorobenzene, chlorotrinitrobenzene, bis(trichloromethyl)carbonate, fluorotrinitrobenzene, 1,2-Bis(2,2-difluoro-2-nitroacetoxyethane), or a combination thereof.

44. The remediation method of any one of paragraphs 30 to 37 for decomposing the oxidized organic compounds, the remediation method involving contacting the oxidized organic compounds with the composition of any one of paragraphs 1 to 29.

45. The remediation method of any one of paragraphs 30 to 37, or 44, wherein the oxidized organic compounds contain one or more nitro-groups.

46. The remediation method of any one of paragraphs 30 to 37, 44, or 45, wherein the oxidized organic compounds contain octahydro-1,3,5,7-tetranitro-1,3,5,7-tetrazocine (HMX), 2,4,6-trinitrotoluene (TNT), 1,3,5-trinitro-1,3,5-triazine (RDX), trinitrobenzenes (TNB), nitrobenzene, nitrocellulose, nitroglycerin, nitromethane, aminodinitrotoluenes (ADNTs), diaminonitrotoluenes (DANTs), 2,4,6-trinitrophenol (TNP), triamino-trinitrobenzene (TATNB), dinitrotoluenes (DNTs), 2,4,6-trinitrophenyl-N-methylnitramine, or a combination thereof.

47. The remediation method of any one of paragraphs 30 to 46, wherein the method is performed in a heat-exchange reactor.

### EXAMPLES

### Example 1

### Neutralization and Non-Explosive Destruction of Ammonium Nitrate

i. Materials and Methods

Materials and conditions employed in the present study are shown in Table 1. As shown in Table 1, the concentrations in controls and treatments were the same for comparison purposes at the end of the treatments. The mass of ammonium nitrate was doubled in treatments due to higher volume.

TABLE 1
Non-limiting compositions for the non-explosive decomposition
of ammonium nitrate

| | | | AN + |
|---|---|---|---|
| Sample | | Mass | NaOH |
| ID | Sample Description | (g) | Vol (mL) |
| AL1-10 | Zero-valent Al Powder (100 g) plus Ram | 10 | 200 |
| AL1-20 | Bamboo Biochar (11 g) | 20 | 200 |
| AL2-10 | Zero-valent Al Powder (90 g) plus | 10 | 200 |
| AL2-20 | OxyBiochar (10 g) | 20 | 200 |
| | OxyBiochar was prepared aging raw | | |
| | hardwood biochar in aqueous solution of | | |
| | Ca(OH)₂ for 72 hours | | |
| AL3-10 | Zero-valent Al Powder (90 g) plus | 10 | 200 |
| AL3-20 | OxyBiochar (10 g) | 20 | 200 |
| | OxyBiochar was prepared aging raw peanut | | |
| | hull (peanut shell) biochar in aqueous | | |
| | solution of Ca(OH)₂ for 72 hours | | |
| AL4-10 | Zero-valent Al Powder (90 g) plus Ram | 10 | 200 |
| AL4-20 | Bamboo Biochar (5 g) and Steal slag | 20 | 200 |
| | (10 g) | | |
| AL5-10 | Zero-valent Al Powder (90 g) plus | 10 | 200 |
| AL5-20 | OxyBiochar (5 g) | 20 | 200 |
| | OxyBiochar was prepared aging raw | | |
| | Bamboo biochar in aqueous solution of | | |
| | Ca(OH)₂ for 72 hours | | |
| ANOH | Ammonium Nitrate (AN) solution with pH | 0 | 100 |
| Control | adjusted to 13 by adding NaOH | 0 | 100 |
| | (Acronym = ANOH) | | |
| AN | Ammonium Nitrate (AN) solution-AN plus | 0 | 100 |
| Control | tap water only | | |
| AN | | 0 | 100 |
| Control | | | |

AN = ammonium nitrate; ANOH = ammonium nitrate solution with pH adjusted to 13 using 1M NaOH solution.
AN + NaOH = 15 grams of ammonium nitrate in 1,500 L of tap water.
ANOH control = pH was adjusted using a 1M solution of NaOH.
A temperature of the exothermic reaction recorded was 95° C.
Reactions with oxybiochar and AN solution was immediate.
The reaction lasted from 12:52-2:45 PM, a little under two hours

ii. Results

The results from the analysis of the amounts of ammonium and nitrate in samples post-treatment with the samples in Table 1, are shown in Table 2.

TABLE 2
The amounts of ammonium and nitrate post-treatment
with the samples in Table 1.

| | Mass | AN + NaOH | NH4—N | NO3—N |
|---|---|---|---|---|
| Sample ID | (g) | Vol (mL) | (mg N/L) | (mg N/L) |
| AL1-10 | 10 | 200 | 3.55 | Not Detected |
| AL1-20 | 20 | 200 | 0.29 | 0.37 |
| AL2-10 | 10 | 200 | 3.35 | 34.65 |
| AL2-20 | 20 | 200 | 0.26 | 1.56 |
| AL3-10 | 10 | 200 | 6.25 | Not Detected |
| AL3-20 | 20 | 200 | 1.48 | Not Detected |
| AL4-10 | 10 | 200 | 5.39 | Not Detected |
| AL4-20 | 20 | 200 | 1.12 | 5.29 |
| AL5-10 | 10 | 200 | 4.36 | Not Detected |
| AL5-20 | 20 | 200 | 0.43 | 0.49 |
| ANOH Control | 0 | 100 | 1204.36 | 1190.56 |
| | 0 | 100 | 1150.84 | 1201.04 |
| AN Control | 0 | 100 | 1546.74 | 1609.38 |
| AN Control | 0 | 100 | 1378.35 | 1479.42 |

AN = ammonium nitrate; ANOH = ammonium nitrate solution with pH adjusted to 13 using 1M NaOH solution.
AN + NaOH = 15 grams of ammonium nitrate in 1,500 L of tap water.
ANOH control = pH was adjusted using a 1M solution of NaOH.
A temperature of the exothermic reaction recorded was 95° C.
Reactions with oxybiochar and AN solution was immediate.
The reaction lasted from 12:52-2:45 PM, a little under two hours

As shown in Table 2, the treatments were more effective than the controls, thus small amounts of ammonium and nitrate remained at the end of the tests.

While a combination of zero-valent aluminum powders from different sources, such as aluminum powder produced from recycled aluminum cans, aluminum foil, aluminum dross, and commercially available aluminum powder can be used, the most effective mixture contain zero-valent aluminum from commercial sources, with the smallest particle sizes, mixed with biochar to produce a more stable final product with a dark gray color. Size fraction and purity of the aluminum can be important factors in achieving the fastest kinetics.

The analysis of the unreacted ZVMBC by X-ray diffraction (XRD) confirmed the presence of elemental aluminum (i.e., aluminum with an oxidation state of zero), aluminum hydroxide (bayerite), and black carbon. The black carbon, specifically biochar in this case, was produced by pyrolysis of plant biomass, for example bamboo, soft or hardwood, peanut hull biomass. The black carbon made from bamboo biomass (bamboo biochar) was relatively more effective. Equally effective, was non-bamboo biochar treated with alkali or alkali earth metals hydroxide and/or hydrogen peroxide. This oxidized biochar was denoted oxybiochar. After the reaction of the ZVMBC with ammonium nitrate, the remaining sludge analyzed by XRD confirmed the presence of aluminum hydroxide and hydrated aluminum oxide (Al₂O₃.H₂O). Exemplary ammonium nitrate decomposition reactions using different amounts of biochar are shown below:
Lower concentration of biochar (5% wt/wt of the mixture prior to contacting with ammonium nitrate sample.)
NH₄NO₃+2Al+C+2NaOH→N₂+Al₂O₃+3H₂+Na₂O+CO NH₄NO₃+2Al+C+2NaOH→N₂+Na₂Al₂O₄+3H₂+CO
Higher concentration of biochar (7.3% wt/wt of the mixture prior to contacting with ammonium nitrate sample.)
2NH₄NO₃+2Al+2C+2NaOH→N₂+2NH₄OH+Na₂Al₂O₄+2CO 2NH₄NO₃+2Al+3C+4NaOH→4NH₃+Na₂AL₂O₄+3CO (faster and more exothermic. The CO converts to CO₂ as it is released from the reactor. Thus, the equation below.)
2NH₄NO₃+2Al+3C+4NaOH+1/2O₂→4NH₃+Na₂AL₂O₄+Na₂CO₃+2CO₂ (faster and more exothermic)
2NH₄NO₃+2Al+4C+3Ca(OH)₂→4NH₃+CaAl₂O₄+2CaCO₃+2CO+H₂ (slower kinetics and less exothermic)
3NH₄NO₃+2Al+5C+2NaOH→4NH₃+3CO+2Na₂AL₂O₄+2HCN (where C is dominated by black carbon and not oxybiochar and/or pH less than 10)

The XRD results show that type of biochar and metal (e.g., Al) determine the end-products. The first equation shows a test performed with 5% wt/wt biochar from soft wood. Subsequently, the metal (e.g., Al) was mixed with bamboo biochar or oxybiochar—yielding a much faster reaction that was mostly complete in less than 4 hours. The oxybiochar and bamboo biochar contained more oxidized surface carbon sites, potentially contributing to the formation of NH₄OH as an intermediary product.

In the non-limiting reactions shown above, it is believed that Na₂Al₂O₄ (sodium aluminate) forms from the dissolution of aluminum hydroxide in alkaline solution. Sodium aluminate forms the sludge from the reaction. The sodium aluminate can be effective for the solidification of concrete, e.g., ecocement made from ground glass and paper waste sludge ash.

Further, sodium aluminate mixed with biochar and/or oxybiochar can be effective for the sorption and precipitation of boron in coal ash.

In the non-limiting reactions shown above, the calcium aluminate and sodium aluminate precipitates can be dissolved using 70% glycolic acid. Alternatively, a solution of urea and hydrochloric acid (1:1 mole basis) forms urea hydrochloride, which can also be used to dissolve the calcium aluminate and sodium aluminate precipitate.

Below are additional laboratory results including compositions and methods described herein.

TABLE 3
The amounts of ammonium and nitrate post-treatment.

| | AN | Reagent | H₂O | | Detergent | NH₃ | HCN | | | NH₄⁺ | NO₃⁻ |
|---|---|---|---|---|---|---|---|---|---|---|---|
| Sample | product | mass | added | Ca(OH)₂ | added | conc. | conc. | LEL | Time/ | conc. | conc. |
| name | mass (g) | (g) | (mL) | mass (g) | (mL) | (ppm) | (ppm) | (%) | Notes | (mg/L) | (mg/L) |
| DJ-1A/B | 2 | 10 | 225 | 2 | N/A | >100 | >50 | >100 | Measured | 260.5 | ND |
| | | | | | | | | | 1307 | | |
| DJ-2A/B | 2.2 | 10 | 225 | 2 | 3 | >100 | >50 | >100 | Measured | 462.3 | ND |
| | | | | | | | | | 1217 | | |
| DJ-3A/B | 2 | 10 | 225 | 2 | 3 | >100 | >50 | >100 | Measured | 478.9 | ND |
| | | | | | | | | | 1226 | | |
| VA-1A/B | 2 | 10 | 225 | N/A | N/A | >100 | >50 | 35 | Measured | 326.9 | ND |
| | | | | | | | | | 1248 | | |
| VA-2A/B | 2.2 | 10 | 225 | N/A | 3 | 92 | >50 | 55 | | 268.6 | ND |
| VA-3A/B | 2 | 10 | 225 | N/A | 3 | 58 | >50 | 44 | | 362.6 | ND |
| CC-1A/B | 2 | 0 | 225 | 0 | 0 | | | | | 673.4 | 538.1 |
| CC-2A/B | 2.2 | 0 | 225 | 0 | 3 | | | | | 477.7 | 344.9 |
| CC-3A/B | 3.6 | 0 | 225 | 0 | 3 | | | | | 463 | 313.5 |

AN = ammonium nitrate; LEL = lower explosive limit

TABLE 4
The amounts of ammonium and nitrate post-treatment.

| | | | Reagent | Water | | | | HCN | | NH₄⁺ | NO₃⁻ |
|---|---|---|---|---|---|---|---|---|---|---|---|
| | Sample | AN product | mass | added | Ca(OH)₂ | Detergent | NH₃ conc. | conc. | LEL | conc | conc. |
| Composition | name | mass (g) | (g) | (mL) | mass (g) | added (mL) | (ppm) | (ppm) | (%) | (mg/L) | (g) |
| Prill + Ca(OH)₂ | RC-1 | 2 | 10 | 500 | 2 | N/A | 77 | 0 | 0 | 683 | ND |
| Matrix + Ca(OH)₂ | RC-2 | 2.2 | 10 | 500 | 2 | 3 | >100 | 0 | 0 | 970.9 | 26.5 |
| Emulsion + | RC-3 | 3.6 | 10 | 500 | 2 | 3 | >100 | 0 | 0 | 999.3 | 9.7 |
| Ca(OH)₂ | | | | | | | | | | | |
| Prill + NaOH | KK-1 | 2 | 10 | 500 | N/A | N/A | >100 | 0 | 0 | 468.6 | ND |
| Matrix + NaOH | KK-2 | 2.2 | 10 | 500 | N/A | N/A | >100 | 10 | 5 | 655.2 | 48.2 |
| Emulsion + NaOH | KK-3 | 3.6 | 10 | 500 | N/A | N/A | >100 | 0 | 0 | 905.8 | 111.2 |
| Prill-control | VJ-1 | 2 | 0 | 500 | 0 | 0 | N/A | N/A | N/A | 600.8 | 505.4 |
| Matrix-control | VJ-2 | 2.2 | 0 | 500 | 0 | 0 | N/A | N/A | N/A | 178.2 | 21.4 |
| Emulsion-control | VJ-3 | 3.6 | 0 | 500 | 0 | 0 | N/A | N/A | N/A | 185.8 | 47.6 |

AN = ammonium nitrate; LEL = lower explosive limit

TABLE 5
Compositions and test results.

| AN | | AL | | | NH₃ | HCN | | VOC | | |
|---|---|---|---|---|---|---|---|---|---|---|
| mass | Oxybiochar | mass | Ca(OH)₂ | | conc. | conc. | CO conc. | conc. | | |
| (g) | mass (g) | (g) | (g) | NaOH (g) | (ppm) | (ppm) | (ppm) | (ppm) | LEL (%) | |
| 5 | 8 | 2 | 1 | N/A | >100 | 25 | 80 | 8 | 0 | pH = 8-9 |
| 5 | 8 | 2 | N/A | 1.6 | 75 | 0 | 0 | 44 | 0 | pH = 8-9 |
| 5 | 0 | 5 | N/A | 1.6 | >100 | >50 | >500 | 200 | 10 | pH = 9 |

AN = ammonium nitrate; AL = aluminum; LEL = lower explosive limit; VOC = volatile organic compounds

Those skilled in the art will recognize, or be able to ascertain using no more than routine experimentation, many equivalents to the specific embodiments of the invention described herein. Such equivalents are intended to be encompassed by the following claims.

We claim:

1. A composition comprising a mixture of:
(i) a zero-valent metal, and
(ii) oxidized black carbon.

2. The composition of claim 1, wherein the zero-valent metal is paramagnetic or non-ferromagnetic, preferably wherein the zero-valent metal is not iron.

3. The composition of claim 1, wherein the zero-valent metal has three valence electrons, is a p-block metal of the periodic table, or a combination thereof.

4. The composition of claim 1, wherein the zero-valent metal is a Group 13 metal of a periodic table.

5. The composition of claim 1, wherein the zero-valent metal is aluminum.

6. The composition of claim 1, wherein the zero-valent metal is in a powder form.

7. The composition of claim 1, wherein the zero-valent metal comprises between about 48.8% wt/wt and about 78.8% wt/wt, 55% wt/wt and 85% wt/wt, inclusive, 55% wt/wt and 80% wt/wt, inclusive, 50% wt/wt and 85% wt/wt, inclusive, or 50% wt/wt and 80% wt/wt, inclusive, of the mixture.

8. The composition of claim 1, wherein the zero-valent metal comprises between about 48.8% wt/wt and about 78.8% wt/wt.

9. The composition of claim 1, further comprising a metal salt.

10. The composition of claim 9, wherein the salt comprises a hydroxide, oxide, sulfate, sulfite, or a combination thereof.

11. The composition of claim 9, wherein the salt comprises a hydroxide.

12. The composition of claim 9, wherein the metal salt comprises an alkali metal, an alkaline earth metal, a salt of the zero-valent metal, or a combination thereof.

13. The composition of claim 9, wherein the metal salt comprises an alkali metal, an alkaline earth metal, or a combination thereof.

14. The composition of claim 9, wherein the metal salt comprises sodium hydroxide, calcium hydroxide, or a combination thereof.

15. The composition of claim 14, wherein the zero-valent metal is aluminum.

16. The composition of claim 9, wherein the metal salt comprises a salt of the zero-valent metal.

17. The composition of claim 1, wherein the oxidized black carbon is based on biomass.

18. The composition of claim 1, wherein the oxidized black carbon is plant-based.

19. The composition of claim 1, wherein the oxidized black carbon is wood-based, crop-based, or a combination thereof.

20. The composition of claim 1, wherein the oxidized black carbon is bamboo-based, softwood-based, hardwood-based, peanut hull-based, wheat straw-based, rice straw-based, maize straw-based, rice husk-based, coconut shell-based, or a combination thereof.

21. The composition of claim 1, wherein the oxidized black carbon is bamboo-based.

22. The composition of claim 1, wherein the oxidized black carbon comprises between 1% wt/wt and 20% wt/wt, inclusive, 1% wt/wt and 15% wt/wt, inclusive, 1% wt/wt and 10% wt/wt, inclusive, 5% wt/wt and 20% wt/wt, inclusive, 5% wt/wt and 15% wt/wt, inclusive, or 5% wt/wt and 10% wt/wt, inclusive, of the mixture.

23. The composition of claim 1, wherein the oxidized black carbon comprises between 5% wt/wt and 10% wt/wt, inclusive, of the mixture.

24. The composition of claim 1, wherein the oxidized black carbon comprises about 7.3% wt/wt, of the mixture.

25. The composition of claim 1, wherein the oxidized black carbon comprises about 5% wt/wt of the mixture.

26. The composition of claim 1, wherein the mixture is in particulate form having particles with particle sizes between 2 mesh and 20 mesh, inclusive, between 2 mesh and 15 mesh, inclusive, or between 2 mesh and 10 mesh, inclusive.

27. The composition of claim 26, wherein the particles comprise:
(i) particles of oxidized black carbon adsorbed with particles of the zero-valent metal,
(ii) particles of oxidized black carbon and particles of the zero-valent metal, not adsorbed with each other, or
(iii) a combination of (i) and (ii).

28. The composition of claim 1, wherein the oxidized black carbon comprises oxybiochar.

29. The composition of claim 1 in solid form, wherein the mixture comprises sodium hydroxide, aluminum, and oxybiochar.

30. A remediation method for decomposing oxidized inorganic compounds, halogenated organic compounds, and/or oxidized organic compounds, the remediation method comprising:
contacting the oxidized inorganic compounds, halogenated organic compounds, and/or oxidized organic compounds with the composition of claim 1.

31. The method of claim 30, comprising first adding an alkaline earth metal salt to the composition and allowing a decomposition to proceed.

32. The method of claim 31, comprising subsequently adding an alkaline metal salt to the decomposition reaction after about 1 min to about 1 hour, about 1 min to about 2 hours, or about 1 min to about 3 hours.

33. The method of claim 30, wherein decomposing the oxidized inorganic compounds, halogenated organic compounds, and/or oxidized organic compounds occurs in an aqueous environment, such as an aqueous solution.

34. The method of claim 30, wherein decomposing the oxidized inorganic compounds, halogenated organic compounds, and/or oxidized organic compounds occurs in the presence of water.

35. The method of claim 30, wherein decomposing the oxidized inorganic compounds, halogenated organic compounds, and/or oxidized organic compounds occurs in alkaline pH.

36. The method of claim 35, wherein the alkaline pH is at least 10 or at least 12.

37. The method of claim 35, wherein the alkaline pH is between 12 and 13, inclusive.

38. The remediation method of claim 30 for decomposing the oxidized inorganic compounds, the remediation method comprising contacting the oxidized inorganic compounds with the composition of claim 1.

39. The remediation method of claim 30, wherein the oxidized inorganic compounds comprise inorganic nitrate compounds.

40. The remediation method of claim 39, wherein the inorganic nitrate compounds comprise ammonium nitrate, alkali metal nitrates, or a combination thereof.

41. The remediation method of claim 39, wherein the inorganic nitrate compounds comprise ammonium nitrate.

42. The remediation method of claim 30 for decomposing the halogenated organic compounds, the remediation method comprising contacting the halogenated organic compounds with the composition of claim 1.

43. The remediation method of claim 30, wherein the halogenated organic compounds comprise trichloroethylene, tetrachloroethylene, a chemical warfare agent, tetrachlorobenzene, chlorotrinitrobenzene, bis(trichloromethyl)carbonate, fluorotrinitrobenzene, 1,2-Bis(2,2-difluoro-2-nitroacetoxyethane), or a combination thereof.

44. The remediation method of claim 30 for decomposing the oxidized organic compounds, the remediation method comprising contacting the oxidized organic compounds with the composition of claim 1.

45. The remediation method of claim 30, wherein the oxidized organic compounds comprise one or more nitro-groups.

46. The remediation method of claim 30, wherein the oxidized organic compounds comprise octahydro-1,3,5,7-tetranitro-1,3,5,7-tetrazocine (HMX), 2,4,6-trinitrotoluene (TNT), 1,3,5-trinitro-1,3,5-triazine (RDX), trinitrobenzenes (TNB), nitrobenzene, nitrocellulose, nitroglycerin, nitromethane, aminodinitrotoluenes (ADNTs), diaminonitrotoluenes (DANTs), 2,4,6-trinitrophenol (TNP), triamino-trinitrobenzene (TATNB), dinitrotoluenes (DNTs), 2,4,6-trinitrophenyl-N-methylnitramine, or a combination thereof.

47. The remediation method of claim 30, wherein the method is performed in a heat-exchange reactor.
